(19) United States
(12) Patent Application Publication
(10) Pub. No.: US 2021/0147150 A1
(43) Pub. Date: May 20, 2021

(54) Position and orientation deviation detection method and system for shelf based on graphic with feature information

(71) Applicant: Zhejiang Guozi Robot Technology Co., Ltd., Hangzhou (CN)

(72) Inventors: Hong HUANG, Hangzhou (CN); Yikun TAO, Hangzhou (CN); Xia WANG, Hangzhou (CN); Hongbo ZHENG, Hangzhou (CN); Lingfen ZHU, Hangzhou (CN); Xinfeng DU, Hangzhou (CN); Xudong MI, Hangzhou (CN)

(21) Appl. No.: 17/095,596

(22) Filed: Nov. 11, 2020

Related U.S. Application Data
(63) Continuation-in-part of application No. 15/305,555, filed on Oct. 20, 2016, now abandoned.

(51) Int. Cl. B65G 1/137; B65G 1/04; B65G 1/10; B25J 9/16; G06T 7/73; G05D 1/02

(52) U.S. Cl. CPC B65G 1/1378; B65G 1/0492; B65G 1/10; B25J 9/1697; G05D 2201/0216; G06T 7/73; G05D 1/0274; G05D 1/0221; G05D 1/0219; B25J 9/1692

(57) ABSTRACT

A position and orientation deviation detection method for a shelf based on a graphic with feature information is provided, wherein an up-looking camera is installed on a robot, an optical axis of the camera faces the shelf and is perpendicular to a side of the shelf facing the robot, and a graphic with feature information is provided on the side; and the method comprises the steps of: the robot moving to a position under the shelf; the robot jacking up the shelf, and then the up-looking camera scanning the graphic; acquiring a position and orientation of the shelf relative to the robot according to the scanned graphic; acquiring a position of the robot within a work space, and acquiring a position of the shelf within the work space according to the position of the robot and the position and orientation of the shelf relative to the robot; and adjusting a position and orientation of the robot according to a deviation between the position of the shelf within the work space and a preset position of the shelf, and then the robot unloading the shelf, such that the shelf is located at the preset position.

### FIELD OF THE INVENTION

The present application relates to warehouse shelf detection, and in particular to a position and orientation deviation detection method and system for a shelf based on a graphic with feature information.

### DESCRIPTION OF THE PRIOR ART

Fast and accurate automated material sorting is an increasingly clear and unavoidable trend for a modern warehouse material management system. A mobile robot is an important constituent part of an automated material sorting system, and it achieves automated scheduling and carrying of a shelf by jacking up, carrying, and putting down the shelf according to a preset procedure. However, in the whole process of carrying the shelf by the robot, a position of the shelf gradually deviates from its preset position because there are errors in both the jacking up and putting down and the robot movement. When the deviated position is greater than a certain threshold, the robot will no longer be able to carry the shelf normally. This will lead to the failure of the entire automated sorting system.

An existing technology for avoiding amplifying a shelf deviation restricts the shelf from deviating from the preset position by precisely controlling the movement of the robot on one hand and by making matched limit devices on a jacking mechanism of the robot and the shelf on the other hand. The limit devices prevent position and orientation deviations of the shelf and the robot from diverging, and the precise robot movement control prevents a deviation of the robot from the preset position from diverging, so that the shelf can be stabilized within an acceptable deviation range of a preset position and orientation. However, it is necessary to design and process the limit device, a processing cycle is long, the cost is high, and the shelf needs to be modified because the limit device needs to be installed, so the versatility of the shelf is a big problem. A deviation tolerated by the limit device is limited, so there is a circumstance that a too large deviation causes the failure of the limit device.

In automated material sorting in a warehouse, it is necessary to detect the position and orientation deviation of the shelf. For a warehouse, the arrangement, classification, storage, and dispatch of materials is a very important and complicated matter. Especially for a large warehouse, after the types and numbers of materials are large to a certain extent, how to ensure that this matter is going on in a normal and orderly way becomes very difficult. A traditional manual sorting method has become increasingly unable to adapt to management of a modernized warehouse, and has been replaced by automated sorting established on the basis of information and industrialization. For modern warehouse material management, it is an irreversible trend to transform from a manual method to a semi-manual and semi-automated method or even a fully-automated method. The automated material sorting system of the warehouse generally comprises maintenance and management of material data, traffic scheduling of a mobile robot, and movement and execution control of the mobile robot. It can be seen that the mobile robot plays a very important role in the entire system.

A general work procedure of the mobile robot is to accept scheduling instructions, move to a specified position and orientation, jack up a shelf, move to a target position and orientation, and put down the shelf. In the entire procedure, in addition to ensuring that the robot moves and stops precisely according to the instructions, the robot needs to ensure that the shelf is placed within an allowable error range of a preset position and orientation. However, because there is a random error in the robot's movement and stop, and this error may cause a change in a position and orientation at which the shelf is stopped and placed, the shelf may deviate from the allowable error range of the preset position and orientation after the shelf is stopped and placed many times during a long time, thus resulting in the failure of subsequent carrying.

### SUMMARY OF THE INVENTION

In order to solve the above problems, the present application provides a robot on which an up-looking camera is installed; when the robot is located under a shelf, an optical axis of the up-looking camera faces the shelf and is perpendicular to a side of the shelf facing the robot; and a graphic with feature information is provided on the side of the shelf facing the robot; and

the method comprises the following steps of:
the robot moving to a position under the shelf;
the robot jacking up the shelf, and then the up-looking camera scanning the graphic;
acquiring a position and orientation of the shelf relative to the robot according to the scanned graphic;
acquiring a position of the robot within a work space, and acquiring a position of the shelf within the work space according to the position of the robot and the position and orientation of the shelf relative to the robot; and
adjusting a position and orientation of the robot according to a deviation between the position of the shelf within the work space and a preset position of the shelf, and then the robot unloading the shelf, such that the shelf is located at the preset position.

In some implementations, optionally, the following step is further comprised: calibrating a mapping relationship between a pixel coordinate system of the camera and a robot coordinate system.

In some implementations, optionally, the mapping relationship refers to a homography matrix H of the camera, and the mathematical meaning of the homography matrix H is:

$$\begin{matrix}[ \begin{matrix}{x}^{′} \\ {y}^{′} \\ {z}^{′}\end{matrix} ] = H * [ \begin{matrix}u \\ v \\ 1\end{matrix} ] & ( Formula 1 ) \\ [ \begin{matrix}x \\ y\end{matrix} ] = [ \begin{matrix}{x}^{′} / {z}^{′} \\ {y}^{′} / {z}^{′}\end{matrix} ] & ( Formula 2 )\end{matrix}$$

wherein the side of the shelf facing the robot is selected as a reference plane,

$$[ \begin{matrix}u \\ v\end{matrix} ]$$

are pixel coordinates of a point, which is on the reference plane, on a camera imaging plane, and

$$[ \begin{matrix}x \\ y\end{matrix} ]$$

are coordinates of a point, which is on the reference plane, in the robot coordinate system; and

$$[ \begin{matrix}{x}^{′} \\ {y}^{′} \\ {z}^{′}\end{matrix} ]$$

are homogeneous coordinates.

In some implementations, optionally, a calibration method for the homography matrix H comprises: obtaining pixel coordinates of more than four points, which are on the reference plane, on the camera imaging plane and coordinates of those in the robot coordinate system, and then calling a homography matrix calculation function in an open source vision library opencv to obtain H.

In some implementations, optionally, the following step is further comprised: measuring coordinates of a feature point of the graphic in a shelf coordinate system.

In some implementations, optionally, said acquiring a position and orientation of the shelf relative to the robot according to the scanned graphic comprises the following steps of:

obtaining pixel coordinates of the feature point of the graphic;
obtaining, through calculation based on the mapping relationship between the pixel coordinate system and the robot coordinate system, coordinates to which the pixel coordinates of the feature point of the graphic are mapped in the robot coordinate system; and
calculating a position and orientation deviation of the shelf relative to the robot according to coordinates of a plurality of feature points of the graphic in the shelf coordinate system and coordinates of those in the robot coordinate system.

In some implementations, optionally, the position and orientation deviation of the shelf relative to the robot is obtained through calculation based on the following formula:

$$[ \begin{matrix}1 & 0 & {x}_{h} & - {y}_{h} \\ 0 & 1 & {y}_{h} & {x}_{h}\end{matrix} ] * [ \begin{matrix}{x}_{1} \\ {x}_{2} \\ {x}_{3} \\ {x}_{4}\end{matrix} ] = [ \begin{matrix}{x}_{r} \\ {y}_{r}\end{matrix} ] \qquad ( Formula 3 )$$

wherein the coordinates of the plurality of detected feature points in the shelf coordinate system and the coordinates of those in the robot coordinate system are substituted into Formula 3, x₁, x₂, x₃, x₄ are calculated in a linear least square method, x₃, x₄ are then normalized, and dθ is calculated according to an inverse trigonometric function after the normalization, so as to obtain

$$[ \begin{matrix}d x \\ d y \\ d θ\end{matrix} ] ;$$

wherein x₁=dx, x₂=dy, x₃=cos dθ, x₄=sin dθ

$$[ \begin{matrix}{x}_{h} \\ {y}_{h}\end{matrix} ]$$

are the coordinates of the feature point in the shelf coordinate system,

$$[ \begin{matrix}{x}_{r} \\ {y}_{r}\end{matrix} ]$$

are the coordinates of the feature point in the robot coordinate system, and

$$[ \begin{matrix}dx \\ dy \\ d θ\end{matrix} ]$$

is the position and orientation deviation of the shelf relative to the robot.

In some implementations, optionally, the graphic with feature information comprises at least one two-dimensional code.

In some implementations, optionally, the graphic with feature information comprises nine two-dimensional codes.

The present application further provides a position and orientation deviation detection system for a shelf based on a graphic with feature information, comprising:

a robot and a shelf located within a work space, the robot being configured to be capable of moving autonomously within the work space and be possible to move to a position under the shelf and jack up the shelf, wherein the robot has a first side, and the shelf has a second side; and the first side is a side of the robot facing the shelf when the robot moves to the position under the shelf, and the second side is a side of the shelf facing the robot when the robot moves to the position under the shelf;
an up-looking camera provided on the first side of the robot, wherein an optical axis of the up-looking camera faces the shelf and is perpendicular to the second side of the shelf; and
a graphic with feature information that is provided on the second side of the shelf;
wherein the up-looking camera is configured such that when the robot jacks up the shelf, the up-looking camera is capable of scanning the graphic and acquiring pixel coordinates of a feature point of the graphic; and
the position and orientation deviation detection system for a shelf is configured to be capable of acquiring, according to the graphic scanned by the up-looking camera, a position and orientation of the shelf relative to the robot after the robot jacks up the shelf; then obtaining a position of the shelf within the work space through calculation according to the position and orientation and a position of the robot within the work space; and adjusting the position of the robot according to a deviation between the position of the shelf and a preset position, such that the shelf is located at the preset position when the robot unloads the shelf.

In some implementations, optionally, the graphic with feature information comprises a plurality of feature points.

In some implementations, optionally, the graphic with feature information is a two-dimensional code.

In some implementations, optionally, the number of graphics with feature information is at least 2.

In some implementations, optionally, the number of graphics with feature information is 9.

In some implementations, optionally, the up-looking camera has a pixel coordinate system, the robot has a robot coordinate system, and there is a mapping relationship between the pixel coordinate system and the robot coordinate system.

In some implementations, optionally, the mapping relationship refers to a homography matrix H of the camera, and the mathematical meaning of the homography matrix H is:

$$\begin{matrix}[ \begin{matrix}{x}^{′} \\ {y}^{′} \\ {z}^{′}\end{matrix} ] = H * [ \begin{matrix}u \\ v \\ 1\end{matrix} ] & ( Formula 4 ) \\ [ \begin{matrix}x \\ y\end{matrix} ] = [ \begin{matrix}{x}^{′} / {z}^{′} \\ {y}^{′} / {z}^{′}\end{matrix} ] & ( Formula 5 )\end{matrix}$$

wherein the side of the shelf facing the robot is selected as a reference plane,

$$[ \begin{matrix}u \\ v\end{matrix} ]$$

are pixel coordinates of a point, which is on the reference plane, on a camera imaging plane, and

$$[ \begin{matrix}x \\ y\end{matrix} ]$$

are coordinates of a point, which is on the reference plane, in the robot coordinate system; and

$$[ \begin{matrix}{x}^{′} \\ {y}^{′} \\ {z}^{′}\end{matrix} ]$$

are homogeneous coordinates.

In some implementations, optionally, a calibration method for the homography matrix H comprises: obtaining pixel coordinates of more than four points, which are on the reference plane, on the camera imaging plane and coordinates of those in the robot coordinate system, and then calling a homography matrix calculation function in an open source vision library opencv to obtain H.

In some implementations, optionally, the shelf has a shelf coordinate system, and the feature point of the graphic has coordinates in the shelf coordinate system.

In some implementations, optionally, the detection system is configured to:

obtain pixel coordinates of the feature point of the graphic in the pixel coordinate system;
obtain, through calculation based on the mapping relationship between the pixel coordinate system and the robot coordinate system, coordinates to which the pixel coordinates of the feature point of the graphic are mapped in the robot coordinate system: and
calculate a position and orientation deviation of the shelf relative to the robot according to coordinates of a plurality of feature points of the graphic in the shelf coordinate system and coordinates of those in the robot coordinate system.

In some implementations, optionally, the position and orientation deviation of the shelf relative to the robot is obtained through calculation based on the following formula:

$$[ \begin{matrix}1 & 0 & {x}_{h} & - {y}_{h} \\ 0 & 1 & {y}_{h} & {x}_{h}\end{matrix} ] * [ \begin{matrix}{x}_{1} \\ {x}_{2} \\ {x}_{3} \\ {x}_{4}\end{matrix} ] = [ \begin{matrix}{x}_{r} \\ {y}_{r}\end{matrix} ] \qquad ( Formula 6 )$$

wherein the coordinates of the plurality of detected feature points in the shelf substituted into Formula 6, x₁, x₂, x₃ x₄ are calculated in a linear least square method, x₃, x₄ are then normalized, and d is calculated according to an inverse trigonometric function after the normalization, so as to obtain

$$[ \begin{matrix}dx \\ dy \\ d θ\end{matrix} ] ;$$

wherein, x₁=dx, x₂=dy, x₃=cos dθ, x₄=sin dθ,

$$[ \begin{matrix}{x}_{h} \\ {y}_{h}\end{matrix} ]$$

are the coordinates of the feature point in the shelf coordinate system,

$$[ \begin{matrix}{x}_{r} \\ {y}_{r}\end{matrix} ]$$

are the coordinates of the feature point in the robot coordinate system, and

$$[ \begin{matrix}dx \\ dy \\ d θ\end{matrix} ]$$

is the position and orientation deviation of the shelf relative to the robot.

The beneficial effects of the present application are as follows:

1. In the present application, the position and orientation deviation of the shelf is detected by means of the up-looking camera by installing the camera on the robot and pasting a graphic with known feature information on the shelf. The entire implementation process is convenient and quick, and the cost is low because the price of the camera is low and there is no need to modify a huge number of shelves
2. It is only necessary to paste the graphic with feature information on the bottom of the shelf without a need to modify the shelf, so that the system has good versatility
3. In the present application, there is no limit on the number of graphics with feature information pasted on the bottom of the shelf. Theoretically, graphics may be pasted all over the entire bottom of the shelf. The camera only needs to scan any number of graphics to calculate the position and orientation deviation of the shelf. Therefore, theoretically, the shelf can be corrected back to the preset position as long as the camera can scan the bottom of the shelf

### BRIEF DESCRIPTION OF THE DRAWINGS

FIG. 1 is a schematic diagram of a work space of the present application;

FIG. 2 is an example of a system constituted of a mobile robot and a shelf of the present application;

FIG. 3 is a flowchart of a method of the present application;

FIG. 4 is a flowchart of coordinate mapping of the present application;

FIG. 5 is a flowchart of acquiring a position and orientation of a shelf relative to a robot in the present application; and

FIG. 6 is a graphic of a two-dimensional code pasted on the bottom of a shelf in an embodiment of the present application.

### DETAILED DESCRIPTION OF THE PREFERRED EMBODIMENTS

The present application is further described in detail below in conjunction with the accompanying drawings and specific embodiments.

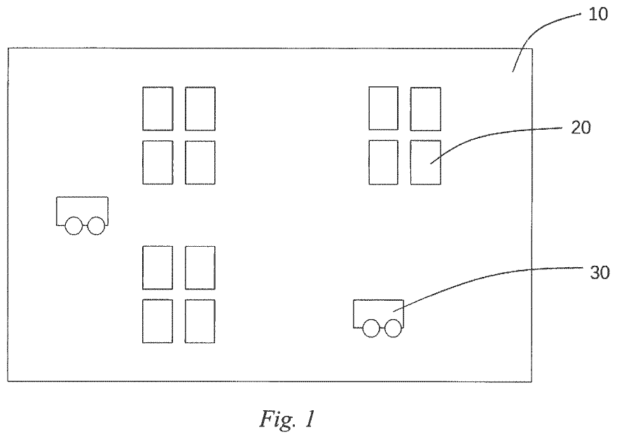

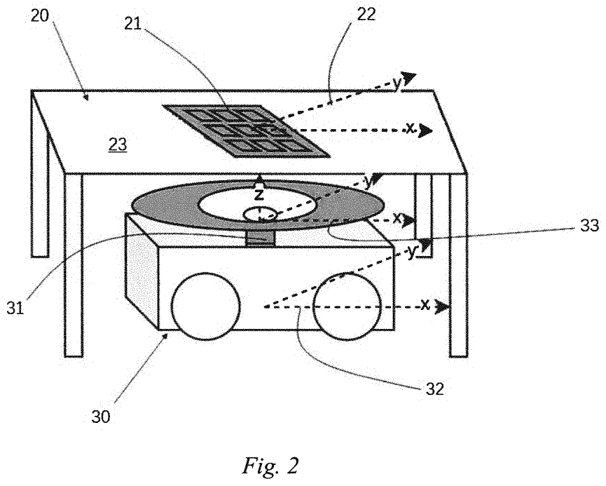

FIG. 1 shows a work space 10 of the present application. There are a plurality of shelves 20 in the work space 10, and a mobile robot 30 moves within the work space 10 and carries the shelves 20. FIG. 2 shows a schematic diagram of the mobile robot 30 and the shelf 20. The mobile robot 30 may move to a position under the shelf 20 and jack up the shelf 20, and then drive the shelf 20 to move to a destination position within the work space 10. After reaching the destination position, the mobile robot 30 unloads the shelf 20 and is separated from the shelf 20. However, in this process, a position of the shelf 20 deviates from a preset position since deviations occur in a jacking process and a moving process of the robot. When the deviated position of the shelf is greater than a certain threshold, the robot 30 may no longer be able to carry the shelf 20 normally.

In order to solve the above problem, the present application proposes a position and orientation deviation detection method for a shelf based on a graphic with feature information, to detect a graphic with feature information on the shelf by means of the mobile robot to achieve the purpose of adjusting the position of the shelf. A system using the method is shown in FIG. 1 and FIG. 2. For ease of description, only one robot 30 and one shelf 20 are shown in FIG. 2. In actual applications, the number of robots and the number of shelves may be set according to actual needs. The robot 30 may move autonomously within the work space 10, and can automatically jack up the shelf 20 and carry the shelf 20 for moving it to another position. The robot 30 may be positioned within the work space 10 according to any existing known technology, for example, may be positioned according to a reference mark provided within the work space, or a position of the robot may be captured by using a sensor provided within the work space, or the robot may be positioned according to a navigation device within the work space. The robot 30 may move within the work space according to any existing known technology. For example, the robot 30 may be configured to have rollers, which are then driven by a power component such as a motor or an engine to rotate. An up-looking camera 31 is installed on the robot 30; and when the robot 30 is located under the shelf 20, an optical axis (which coincides with a Z-axis of a pixel coordinate system 33) of the up-looking camera 31 points in a direction of the shelf, and the optical axis of the up-looking camera 31 is perpendicular to a side 23 of the shelf 20 facing the robot 30; and a graphic 21 with feature information is provided on the side 23 of the shelf 20 facing the robot 30, and the up-looking camera 31 on the robot 30 can scan the graphic 21 when the robot 30 is located under the shelf 20.

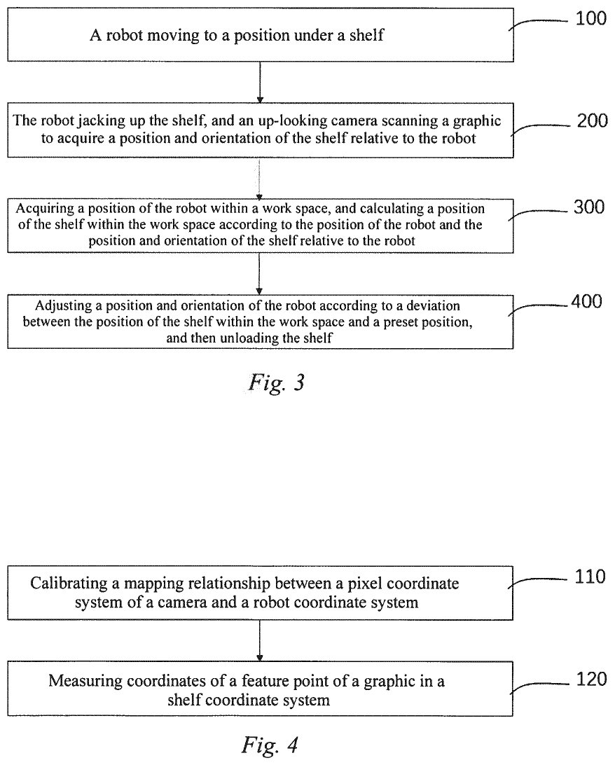

Referring to FIG. 3, a position and orientation deviation detection method for a shelf based on a graphic with feature information that is disclosed in the present application comprises the following steps:

Step 100: a robot 30 moving to a position under a shelf 20;
Step 200: the robot 30 jacking up the shelf 20, then an up-looking camera 31 scanning a graphic 21 with feature information that is provided on the shelf 20, and the robot 30 acquiring a position and orientation of the shelf 20 relative to the robot 30 according to the scanned graphic;
Step 300: acquiring a position of the robot 30 within a work space 10, and obtaining a position of the shelf 20 within the work space 10 according to the position and orientation of the shelf 20 relative to the robot 30 and the position of the robot 30 within the work space 10; and
Step 400: adjusting a position and orientation of the robot 30 according to the position of the shelf 20 within the work space 10 and a preset position of the shelf 20, and then the robot 30 unloading the shelf 20, such that the shelf 20 is located at the preset position.

In the present application, according to the graphic 21 with feature information that is provided on the shelf 20, the robot 30 is enabled to obtain the position and orientation of the shelf 20 relative to the robot 30 after jacking up the shelf 20, so that before unloading the shelf 20, the robot 30 can adjust the position of the robot 30 to make a position where the shelf 20 is located after being unloaded consistent with the preset position, thereby achieving the purpose of adjusting the position of the shelf 20. The adjustment to the position of the shelf 20 may be completed in a process of carrying the shelf 20, so it is simple and quick, and saves operation time.

After the shelf 20 is jacked up by the robot 30, in order to obtain the position and orientation of the shelf 20 relative to the robot 30, the up-looking camera 31 on the robot 30 needs to be used to scan the graphic 21 with feature information that is provided on the shelf 20. Before this step, it is also necessary to establish a mapping relationship between a pixel coordinate system 33 of the camera and a robot coordinate system 32. Referring to FIG. 4, details are as follows:

Step 110: calibrating the mapping relationship between the pixel coordinate system 33 of the camera and the robot coordinate system 32;
wherein the mapping relationship refers to a homography matrix H of the camera, and the mathematical meaning thereof is:

$$\begin{matrix}[ \begin{matrix}{x}^{′} \\ {y}^{′} \\ {z}^{′}\end{matrix} ] = H * [ \begin{matrix}u \\ v \\ 1\end{matrix} ] & ( Formula 1 ) \\ [ \begin{matrix}x \\ y\end{matrix} ] = [ \begin{matrix}{x}^{′} / {z}^{′} \\ {y}^{′} / {z}^{′}\end{matrix} ] & ( Formula 2 )\end{matrix}$$

wherein a second side of the shelf 20 that faces the mobile robot 30 after the robot 30 jacks up the shelf 20 is selected as a reference plane, Error! Objects cannot be created from editing field codes. are pixel coordinates of a point, which is on the reference plane, on a camera imaging plane, and Error! Objects cannot be created from editing field codes. are coordinates of a point, which is on the reference plane, in the robot coordinate system 32. Herein,

$$[ \begin{matrix}{x}^{′} \\ {y}^{′} \\ {z}^{′}\end{matrix} ]$$

are homogeneous coordinates.

A calibration method for H comprises: obtaining pixel coordinates of more than four points, which are on the reference plane, on the camera imaging plane and coordinates of those in the robot coordinate system, and then calling a homography matrix calculation function CV::findHomography in an open source vision library opencv to obtain H. The open source vision library opencv is a cross-platform computer vision and machine learning software library released based on a BSD license (open source), and its official website is http://opencv.org; the homography matrix calculation function CV::findHomography may be viewed on an API description page in the official website, and its access address is:

https://docs.opencv.org/2.4/modules/calib3d/doc/camera_calibration_and_3d_reconstruction.html?highlight=findhomography#findhomography.

The function CV::findHomography is used to find perspective transformation between two planes, and a specific description thereof is as follows (only C++ is used as an example herein for explanation):

C++: Mat findHomography(InputArray srcPoints, InputArray dstPoints, int method=0, double ransacReprojThreshold=3, OutputArray mask=noArray( ) )
wherein a parameter srcPoints represents coordinates of a point in an original plane, a parameter dstPoints represents coordinates of a point in a target plane, a parameter method represents a method for calculating the homography matrix (a value 0 represents a conventional method, a value CV_RANSAC represents a robust method based on RANSAC, and a value CV_LMEDS represents a minimum median robust method), a parameter ransacReprojThrehold is used to consider a point pair as a maximum reprojection error (used only in a RANSAC method) allowed by an interior point, and a parameter mask represents an outputable mask set in a robust method.

A process of calibrating the homography matrix H is: in a non-working state of the robot 30, a graphic 21 with four feature points is pasted on the bottom of the shelf 20; and after jacking up the shelf 20, the robot 30 may directly extract pixel coordinates of the feature points from the graphic of the camera through a program, and coordinates of the feature points in the robot coordinate system 32 may be directly measured manually. The homography matrix H can be obtained by substituting the measured pixel coordinates of the feature points and the coordinates of those in the robot coordinate system 32 into the homography matrix calculation function of the open source vision library opencv, and the calibration is completed.

Step 120: measuring coordinates of a feature point of the graphic 21 in a shelf coordinate system 22.

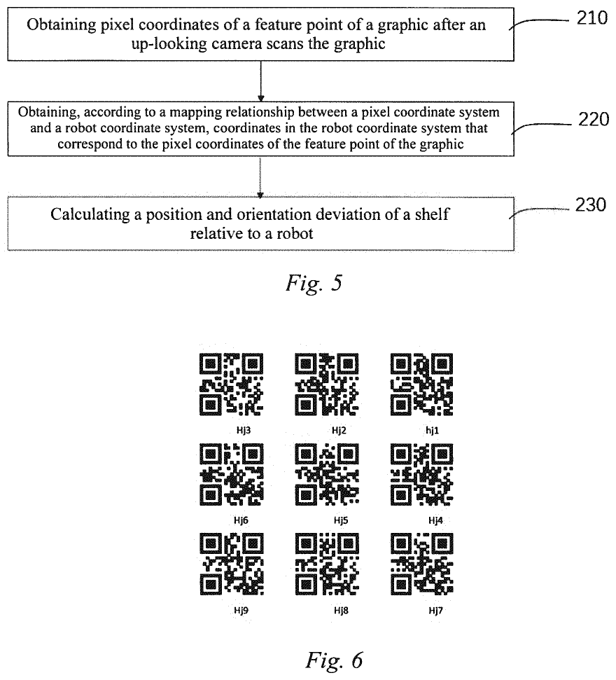

Referring to FIG. 5, after the robot 30 jacks up the shelf 20, after the up-looking camera 31 scans the graphic, specific steps of obtaining, by the robot 30, a position and orientation of the shelf 20 relative to the robot 30 according to the scanned graphic are as follows:

Step 210: obtaining pixel coordinates of the feature point of the graphic after the up-looking camera 31 scans the graphic 21.

Data of the camera is connected to the program, and the program then detects the graphic in an obtained camera image according to the image to obtain the pixel coordinates of the feature point in the graphic.

Step 220: obtaining, through calculation based on the mapping relationship between the pixel coordinate system 33 of the camera and the robot coordinate system 32, coordinates to which the pixel coordinates of the feature point of the graphic are mapped in the robot coordinate system 32; and
Step 230: calculating a position and orientation deviation of the shelf 20 relative to the robot 30 according to coordinates of a plurality of feature points of the graphic in the shelf coordinate system 22 and coordinates of those in the robot coordinate system 32. The position and orientation deviation of the shelf 20 relative to the robot 30 is obtained through calculation based on the following formula: The position and orientation in the present application refers to a position and an orientation, and specifically refers to x and y coordinates and a direction angle (an orientation of the shelf 20) because herein is a two-dimensional space.

Coordinates of a feature point, measured according to the above steps, in the two-dimensional space in the robot coordinate system 32 are

$$[ \begin{matrix}{x}_{r} \\ {y}_{r}\end{matrix} ] ,$$

coordinates of the feature point in the shelf coordinate system 22 are

$$[ \begin{matrix}{x}_{h} \\ {y}_{h}\end{matrix} ] ,$$

and a position and orientation of the shelf coordinate system 22 in the robot coordinate system 32 is represented as

$$[ \begin{matrix}d x \\ d y \\ d θ\end{matrix} ] ,$$

that is, the position and orientation deviation of the shelf 20 relative to the robot 30. Then Euclidean space coordinate transformation (Formula 3) is used to obtain

Error!Objects cannot be created from editing field codes. (Formula 3)

The above formula may be written as

Error!Objects cannot be created from editing field codes. (Formula 4)

If x₁=dx, x₂=dy, x₃=cos dθ, and x₄=sin dθ, then

$$[ \begin{matrix}1 & 0 & {x}_{h} & - {y}_{h} \\ 0 & 1 & {y}_{h} & {x}_{h}\end{matrix} ] * [ \begin{matrix}{x}_{1} \\ {x}_{2} \\ {x}_{3} \\ {x}_{4}\end{matrix} ] = [ \begin{matrix}{x}_{r} \\ {y}_{r}\end{matrix} ] \qquad ( Formula 5 )$$

wherein the coordinates of the plurality of detected feature points in the shelf coordinate system 22 and the coordinates of those in the robot coordinate system 32 are substituted into Formula 5, and x₁, x₂, x₃, x₄ are calculated in a linear least square method, so as to obtain values of Error! Objects cannot be created from editing field codes., Error! Objects cannot be created from editing field codes., sin d Error! Objects cannot be created from editing field codes. and cos dError!Objects cannot be created from editing field codes.

After the calculation, because Error! Objects cannot be created from editing field codes., x₃, x₄ is then normalized, and a normalization equation is

x₃=x₃/\sqrt{x₃²+x₄²} (Formula 6)

x₄=x₄/\sqrt{x₃²+x₄²} (Formula 7)

dθ is calculated according to an inverse trigonometric function after the normalization.

Thus

$$[ \begin{matrix}d x \\ d y \\ d θ\end{matrix} ]$$

is obtained, that is, the position and orientation deviation of the shelf 20 relative to the robot 30 is obtained.

The robot 30 can estimate its own position and orientation in real time, that is, the robot 30 can obtain its real-time position and orientation in the work space 10. After the robot 30 drives the shelf 20 to move to a destination position, since the robot 30 has detected the position and orientation of the shelf 20 relative to the robot 30 after jacking up the shelf 20, the robot 30 may obtain an accurate current position and orientation of the shelf 20 in the work space 10 through calculation according to the position and orientation of the robot in the work space 10 and the position and orientation of the shelf 20 relative to the robot 30, and then the robot 30 can place the shelf 20 at a preset position and orientation by adjusting the position and orientation of the robot 30 in the work space 10 according to a deviation between the current position and orientation of the shelf 20 in the work space 10 and the preset position and orientation of the shelf 20. In such an operation process of jacking up the shelf 20—moving the shelf 20—unloading the shelf 20, the robot 30 can adjust the position and orientation of the shelf 20 before unloading the shelf 20, so that the shelf 20 is accurately placed at the preset position and orientation after being unloaded.

The present application further discloses a position and orientation deviation detection system for a shelf 20 based on a graphic with feature information, comprising a robot 30, an up-looking camera installed on the robot, the shelf 20, and a graphic with feature information that is provided at the bottom of the shelf 20. As shown in FIG. 6, in one embodiment, the graphic with feature information comprises a two-dimensional code, and four corner points of the two-dimensional code are used as feature points of the graphic. In one embodiment, the number of two-dimensional codes is 9, and the nine two-dimensional codes are distributed according to a certain rule. Theoretically, the camera only needs to scan one two-dimensional code to calculate a position and orientation deviation of the shelf 20. Because a field of view of the camera is limited, nine two-dimensional codes are pasted in this embodiment to obtain a large enough deviation detection range, and more two-dimensional codes may be pasted if the range is still not large enough. In one embodiment, if two-dimensional codes are pasted all over the bottom of the shelf 20, the camera only needs to detect any two-dimensional code at the bottom of the shelf 20 to calculate the position and orientation deviation of the shelf 20.

The above description is not intended to limit the invention. Any minor modifications, equivalent replacements, and improvements made to the above embodiments based on the technical essence of the present application should be comprised within the scope of protection of the technical solutions of the present application.

1. A position and orientation deviation detection method for a shelf based on a graphic with feature information, wherein
an up-looking camera is installed on a robot, when the robot is located under the shelf,
an optical axis of the up-looking camera faces the shelf and is perpendicular to a side of the shelf facing the robot, and a graphic with feature information is provided on the side of the shelf facing the robot; and
the method comprises the following steps of:
the robot moving to a position under the shelf;
the robot jacking up the shelf, and then the up-looking camera scanning the graphic;
acquiring a position and orientation of the shelf relative to the robot according to the scanned graphic;
acquiring a position of the robot within a work space, and acquiring a position of the shelf within the work space according to the position of the robot and the position and orientation of the shelf relative to the robot; and
adjusting a position and orientation of the robot according to a deviation between the position of the shelf within the work space and a preset position of the shelf, and then the robot unloading the shelf, such that the shelf is located at the preset position.

2. The position and orientation deviation detection method for a shelf of claim 1, further comprising the following step of: calibrating a mapping relationship between a pixel coordinate system of the camera and a robot coordinate system.

3. The position and orientation deviation detection method for a shelf of claim 2, wherein the mapping relationship refers to a homography matrix H of the camera, and the mathematical meaning of the homography matrix H is:
Error!Objects cannot be created from editing field codes. (Formula 1)
Error!Objects cannot be created from editing field codes. (Formula 2)
wherein the side of the shelf facing the robot is selected as a reference plane, Error!Objects cannot be created from editing field codes. are pixel coordinates of a point, which is on the reference plane, on a camera imaging plane, and Error! Objects cannot be created from editing field codes. are coordinates of a point, which is on the reference plane, in the robot coordinate system; and Error! Objects cannot be created from editing field codes. are homogeneous coordinates.

4. The position and orientation deviation detection method for a shelf of claim 3, wherein a calibration method for the homography matrix H comprises: obtaining pixel coordinates of more than four points, which are on the reference plane, on the camera imaging plane and coordinates of those in the robot coordinate system, and then calling a homography matrix calculation function in an open source vision library opencv to obtain H.

5. The position and orientation deviation detection method for a shelf of claim 2, further comprising the following step of: measuring coordinates of a feature point of the graphic in a shelf coordinate system.

6. The position and orientation deviation detection method for a shelf of claim 5, wherein said acquiring a position and orientation of the shelf relative to the robot according to the scanned graphic comprises the following steps of:
obtaining pixel coordinates of the feature point of the graphic;
obtaining, through calculation based on the mapping relationship between the pixel coordinate system and the robot coordinate system, coordinates to which the pixel coordinates of the feature point of the graphic are mapped in the robot coordinate system; and
calculating a position and orientation deviation of the shelf relative to the robot according to coordinates of a plurality of feature points of the graphic in the shelf coordinate system and coordinates of those in the robot coordinate system.

7. The position and orientation deviation detection method for a shelf of claim 6, wherein the position and orientation deviation of the shelf relative to the robot is obtained through calculation based on the following formula:
Error!Objects cannot be created from editing field codes. (Formula 3)
wherein the coordinates of the plurality of detected feature points in the shelf coordinate system and the coordinates of those in the robot coordinate system are substituted into Formula 3, Error! Objects cannot be created from editing field codes. are calculated in a linear least square method, Error! Objects cannot be created from editing field codes. are then normalized, and Error! Objects cannot be created from editing field codes. is calculated according to an inverse trigonometric function after the normalization, so as to obtain Error! Objects cannot be created from editing field codes.;
wherein Error! Objects cannot be created from editing field codes., Error!Objects cannot be created from editing field codes., Error! Objects cannot be created from editing field codes., Error! Objects cannot be created from editing field codes., Error! Objects cannot be created from editing field codes. are the coordinates of the feature point in the shelf coordinate system, Error! Objects cannot be created from editing field codes. are the coordinates of the feature point in the robot coordinate system, and Error! Objects cannot be created from editing field codes. is the position and orientation deviation of the shelf relative to the robot.

8. The position and orientation deviation detection method for a shelf of claim 1, wherein the graphic with feature information comprises at least one two-dimensional code.

9. The position and orientation deviation detection method for a shelf of claim 8, wherein the graphic with feature information comprises nine two-dimensional codes.

10. A position and orientation deviation detection system for a shelf based on a graphic with feature information, characterized by comprising:
a robot and a shelf located within a work space, the robot being configured to be capable of moving autonomously within the work space and be possible to move to a position under the shelf and jack up the shelf, wherein the robot has a first side, and the shelf has a second side; and the first side is a side of the robot facing the shelf when the robot moves to the position under the shelf, and the second side is a side of the shelf facing the robot when the robot moves to the position under the shelf;
an up-looking camera provided on the first side of the robot, wherein an optical axis of the up-looking camera faces the shelf and is perpendicular to the second side of the shelf; and
a graphic with feature information that is provided on the second side of the shelf;
wherein the up-looking camera is configured such that when the robot jacks up the shelf, the up-looking camera is capable of scanning the graphic and acquiring pixel coordinates of a feature point of the graphic; and
the position and orientation deviation detection system for a shelf is configured to be capable of acquiring, according to the graphic scanned by the up-looking camera, a position and orientation of the shelf relative to the robot after the robot jacks up the shelf; then obtaining a position of the shelf within the work space through calculation according to the position and orientation and a position of the robot within the work space; and adjusting the position of the robot according to a deviation between the position of the shelf and a preset position, such that the shelf is located at the preset position when the robot unloads the shelf.

11. The detection system of claim 10, wherein the graphic with feature information comprises a plurality of feature points.

12. The detection system of claim 10, wherein the graphic with feature information is a two-dimensional code.

13. The detection system of claim 10, wherein the number of graphics with feature information is at least 2.

14. The detection system of claim 13, wherein the number of graphics with feature information is 9.

15. The detection system of claim 10, wherein the up-looking camera has a pixel coordinate system, the robot has a robot coordinate system, and there is a mapping relationship between the pixel coordinate system and the robot coordinate system.

16. The detection system of claim 15, wherein the mapping relationship refers to a homography matrix H of the camera, and the mathematical meaning of the homography matrix H is:
$$\begin{matrix}[ \begin{matrix}{x}^{′} \\ {y}^{′} \\ {z}^{′}\end{matrix} ] = H * [ \begin{matrix}u \\ v \\ 1\end{matrix} ] & ( Formula 4 ) \\ [ \begin{matrix}x \\ y\end{matrix} ] = [ \begin{matrix}{x}^{′} / {z}^{′} \\ {y}^{′} / {z}^{′}\end{matrix} ] & ( Formula 5 )\end{matrix}$$
wherein the side of the shelf facing the robot is selected as a reference plane,
$$[ \begin{matrix}u \\ v\end{matrix} ]$$
are pixel coordinates of a point, which is on the reference plane, on a camera imaging plane, and
$$[ \begin{matrix}x \\ y\end{matrix} ]$$
are coordinates of a point, which is on the reference plane, in the robot coordinate system; and
$$[ \begin{matrix}{x}^{′} \\ {y}^{′} \\ {z}^{′}\end{matrix} ]$$
are homogeneous coordinates.

17. The detection system of claim 16, wherein a calibration method for the homography matrix H comprises: obtaining pixel coordinates of more than four points, which are on the reference plane, on the camera imaging plane and coordinates of those in the robot coordinate system, and then calling a homography matrix calculation function in an open source vision library opencv to obtain H.

18. The detection system of claim 15, wherein the shelf has a shelf coordinate system, and the feature point of the graphic has coordinates in the shelf coordinate system.

19. The detection system of claim 18, wherein the detection system is configured to:
obtain pixel coordinates of the feature point of the graphic in the pixel coordinate system;
obtain, through calculation based on the mapping relationship between the pixel coordinate system and the robot coordinate system, coordinates to which the pixel coordinates of the feature point of the graphic are mapped in the robot coordinate system; and
calculate a position and orientation deviation of the shelf relative to the robot according to coordinates of a plurality of feature points of the graphic in the shelf coordinate system and coordinates of those in the robot coordinate system.

20. The detection system of claim 19, wherein the position and orientation deviation of the shelf relative to the robot is obtained through calculation based on the following formula:
$$[ \begin{matrix}1 & 0 & {x}_{h} & - {y}_{h} \\ 0 & 1 & {y}_{h} & {x}_{h}\end{matrix} ] * [ \begin{matrix}{x}_{1} \\ {x}_{2} \\ {x}_{3} \\ {x}_{4}\end{matrix} ] = [ \begin{matrix}{x}_{r} \\ {y}_{r}\end{matrix} ] \qquad ( Formula 6 )$$
wherein the coordinates of the plurality of detected feature points in the shelf coordinate system and the coordinates of those in the robot coordinate system are substituted into Formula 6, x₁, x₂, x₃, x₄ are calculated in a linear least square method, x₃, x₄ are then normalized, and dθ is calculated according to an inverse trigonometric function after the normalization, so as to obtain
$$[ \begin{matrix}d x \\ d y \\ d θ\end{matrix} ] ;$$
wherein x₁=dx, x₂=dy, x₃=cos dθ, x₄=sin dθ,
$$[ \begin{matrix}{x}_{h} \\ {y}_{h}\end{matrix} ]$$
are the coordinates of the feature point in the shelf coordinate system,
$$[ \begin{matrix}{x}_{r} \\ {y}_{r}\end{matrix} ]$$
are the coordinates of the feature point in the robot coordinate system, and
$$[ \begin{matrix}d x \\ d y \\ d θ\end{matrix} ]$$
is the position and orientation deviation of the shelf relative to the robot.
